(19) United States
(12) Patent Application Publication
(10) Pub. No.: US 2026/0275158 A1
(43) Pub. Date: Sep. 17, 2026

(54) HYBRID EPOXY-POLYSILOXANE WATERBORNE PRIMER, METHODS FOR ITS PREPARATION AND METHODS FOR USING

(71) Applicant: SWIMC LLC, Cleveland, OH (US)

(72) Inventors: Liang LIANG, Twinsburg, OH (US); Peter MAASSEN VAN DEN BRINK, Amsterdam (NL)

(21) Appl. No.: 19/475,455

(22) PCT Filed: Apr. 11, 2024
(86) PCT No.: PCT/US2024/023995

§ 371 Date: Oct. 15, 2025

Related U.S. Application Data
(60) Provisional application No. 63/460,152, filed on Apr. 18, 2023.

(51) Int. Cl. C09D 183/10; C08G 77/42; C09D 5/00

(52) U.S. Cl. CPC C09D 183/10; C08G 77/42; C09D 5/002

(57) ABSTRACT

Hybrid epoxy-polysiloxane waterborne primer compositions are provided, along with methods for their production and their use, where the hybrid epoxy-polysiloxane waterborne primer composition contains a crosslinked network formed from an epoxy resin and a silicon based compound containing one or more amino or hydroxyl functional groups.

### CROSS-REFERENCE TO RELATED APPLICATIONS

The present application is related to, and claims priority to, U.S. Provisional Application Ser. No. 63/460,152, filed Apr. 18, 2023, pending, the entire contents of which are incorporated herein by reference.

### TECHNICAL FIELD

The present invention relates to hybrid epoxy-polysiloxane waterborne primer compositions, methods for their production and methods for using them, particularly as primers on substrates containing metal surfaces.

### BACKGROUND OF THE INVENTION

There is an increasing demand for the development and use of waterborne coatings due to environmental considerations, especially the negative impacts on environment resulting from solvent-borne coating solutions, and particularly the volatile organic compounds (VOC) associated therewith. Solvent borne primers are frequently used in the refinishing of vehicles, which provide improved performance in areas such as anticorrosion. However, the VOC associated with solvent-borne primers is one of the critical issues prompting interest in a switch to waterborne primers.

Low VOC and zero emission are significant advantages of waterborne coatings, providing a motivation to develop various waterborne coating solutions. Many efforts had been addressed to replace solvent-borne primers with waterborne primers. However, past efforts have resulted in poor performance, particularly in the area of anticorrosion, thus restricting the use of waterborne primers, especially for refinishing vehicles and for coating other metal surfaces in particular.

A primer is a paint or coating product that allows finishing paint to adhere to a surface much better than if it were used alone. It is designed to adhere to surfaces and to form a binding layer that is better prepared to receive the paint. Compared to paint, a primer is not typically intended to be used as the outermost durable finish and can instead be engineered to have improved filling and binding properties with the material underneath. Sometimes this can be achieved by chemistry, and others by controlling the primer's physical properties such as its porosity, tackiness, and hygroscopy.

Direct-to-metal (DTM) coatings are designed to provide the performance of traditional primer-topcoat systems, but in one coat. As technologies for the development of DTM coatings have advanced and led to more desirable properties during application and in applied films, demand for these coatings has been increasing. Most primers used in refinished vehicles also use an etch primer, which can improve adhesive strength between substrate and primers, especially when polymer binder in primer without hydroxyl group and other hydrophilic groups, such as polyurethane. Although etch primer can significantly enhance the performance of final coating layer, the cost and process time will be increased. Therefore, to develop coating technology with Direct-to-Metal is highly desirable for business of refinished vehicles. In this study, waterborne primers prepared by hybrid epoxy-polysiloxane with performances of excellent anticorrosion and anti-degradation as well as feature of Direct-to-Metal coating are disclosed.

### SUMMARY OF THE INVENTION

Accordingly one object of the present invention is to provide hybrid waterborne primer compositions that have a combination of properties not otherwise attainable with a single polymer based primer.

A further object of the present invention is to provide hybrid waterborne primer compositions that can be applied to substrates, particularly metal substrates, without the need for use of an etch primer.

A further object of the present invention is to provide hybrid waterborne primer compositions that can be applied to substrates, particularly metal substrates, after initial application of an etch primer, with the hybrid waterborne primer composition providing comparable or improved adhesion, anticorrosion, and anti-hydrolysis properties, among other properties when compared to conventional solvent borne primers used with etch primers.

Another object of the present invention is to provide methods for the production of the hybrid waterborne primer compositions of the present invention, and methods for their use.

These and other objects of this invention, alone or in combination, have been satisfied by the discovery of a hybrid primer comprising a crosslinked network formed from an epoxy resin and a silicon based compound containing one or more amino or hydroxyl functional groups,
methods for its production and for its application in substrate coating, particularly metal substrate coating.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic representation of a grafting reaction of an example organosilicon compound having an amino group used in certain embodiments of the present invention onto substrates of cold rolled steel, and subsequent reaction with an exemplary epoxy resin.

FIG. 2 is a schematic representation of a crosslinking reaction between polysiloxanes formed from an exemplary organosilicon compound having an amino group and an exemplary epoxy resin in certain embodiments of the present invention.

FIG. 3A provides a photographic representation of anticorrosion performance after 20 days of salt spray testing between substrates coated with a conventional polyurethane solvent borne primer control [(a) and (b)] compared to a hybrid epoxy-polysiloxane waterborne primer of certain embodiments of the present invention [(c) and (d)].

FIG. 3B provides a graphical representation of anticorrosion performance from the photographs of FIG. 3A with the darker box values being the control and the lighter box values being embodiments of the present invention.

FIG. 4 is a further photographic representation of anticorrosion performance after 20 days of salt spray testing between substrates coated with a conventional polyurethane solvent borne primer control [(a) and (b)] compared to a hybrid epoxy-polysiloxane waterborne primer of certain embodiments of the present invention [(c) and (d)].

FIG. 4B provides a graphical representation of anticorrosion performance from the photographs of FIG. 4A with the darker box values being the control and the lighter box values being embodiments of the present invention.

FIG. 5 is a schematic representation of the interlocking obtained between 3-aminopropylmethyldiethoxysilane groups and a polyacrylate basecoat in certain embodiments of the hybrid epoxy-polysiloxane waterborne primer of the present invention.

### DETAILED DESCRIPTION OF THE INVENTION

The present invention relates to hybrid epoxy-polysiloxane waterborne primers, methods used to prepare the primers and their use as coatings on substrates, particularly metal substrates. The hybrid epoxy-polysiloxane waterborne primers of the invention can be used alone as a direct-to-substrate (or in certain embodiments, direct-to-metal or “DTM”) primer, or in combination with a surface treatment on the substrate to be coated, such as an etching primer or other chemical surface treatment to render the surface of the substrate better able to receive and bond with the hybrid epoxy-polysiloxane waterborne primer of the invention.

Within the context of the present invention, the term “hybrid primer” includes, but is not limited to, semi- and fully interpenetrating crosslinked networks of two polymer types, blends of two different polymer types that have been chemically bonded either directly or via a linking agent, chemically bonded crosslinked networks of two polymer types, a crosslinked network of one polymer type chemically modified by a compound that then can form its own crosslinked network after bonding to the original crosslinked network, crosslinked networks having two or more regions of different polymer types, and the like.

Within the context of the present invention, the term “waterborne” is intended to mean that the polymeric components are in an aqueous medium. In certain embodiments, waterborne coatings provide one or more of the following advantages:
Low toxicity and flammability due to low VOC levels and low HAP emissions.
Lower cost than solvent-borne coatings and no additives, thinners, or hardeners are required in most cases
Less coating is required to cover the same surface area as compared to the use of solvent borne coating solutions.
Paint guns can be readily cleaned with water or water-based solutions and do not require paint thinner, acetone, or methyl acetate (further environmentally friendly and user safety friendly)

The term “comprises” and variations thereof do not have a limiting meaning where these terms appear in the description and claims.

The recitation of a numerical range using endpoints includes all numbers subsumed within that range (e.g., 1 to 5 includes 1, 1.5, 2, 2.75, 3, 3.80, 4, 5, etc.).

To the extent that the terms “including”, “includes”, “having”, “has”, “with”, or variants thereof are used in the present application, such terms are intended to be inclusive in a manner similar to the term “comprising.” The singular forms “a”, “an” and “the” include plural referents unless the context clearly dictates otherwise. Additionally, the terms “a,” “an,” “the,” “at least one,” and “one or more” are used interchangeably. Thus, for example, a coating composition that contains “an” additive means that the coating composition can include “one or more” additives. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

The term “aqueous” composition or dispersion herein means that particles are dispersed in an aqueous medium. An “aqueous medium” herein has a continuous phase of water that makes up at least 50 weight percent of the aqueous medium, wherein the remaining composition of the aqueous medium comprises particles and water-miscible compound(s) such as, for example, alcohols, glycols, glycol ethers, glycol esters, and the like.

The term “dispersion” in the context of the present invention refers to the mixture of a dispersible polymer and a carrier. The term “dispersion” includes, but is not limited to, the term “solution.”

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein, the term “structural units,” also known as polymerized units, of the named monomer refers to the remnant of the monomer after polymerization, or the monomer in polymerized form.

All methods described herein can be performed in any suitable order unless otherwise indicated herein or otherwise clearly contradicted by context. The use of any examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

In certain embodiments of the invention, the waterborne hybrid primer of the invention is a hybrid epoxy-polysiloxane having excellent anticorrosion and anti-degradation properties. Typically, epoxy resins demonstrate good chemical and thermal stability, adhesive and mechanical strength, which can be used for anti-corrosion properties. However, epoxy resins often exhibit a high rigidity property, which can reduce the flexibility of a coating formed therefrom, and sanding capability is also a challenge, due to slow reaction between epoxide rings and amine groups at room temperature. Poor adhesive strength between basecoat and conventional waterborne epoxy primer is often found as well.

Polysiloxane is a rubber type polymer having more hydrophobic and flexible properties compared with epoxy resins. In certain embodiments of the present invention, epoxy resin and polysiloxane are combined to form a hybrid primer in order to provide the anticorrosion benefits of the epoxy and the flexibility and hydrophobic properties of the polysiloxane in a single hybrid primer composition. The present invention utilizes the hydrophobic property of polysiloxane to provide the capability to prevent penetration of water moisture through the film and the flexibility of polysiloxane chains to offer a softer more flexible property to the final film coated on a substrate, which improves overall flexibility of the film. Further, by using a silicon based compound containing one or more amino or hydroxyl functional groups in providing the polysiloxane based portion of the hybrid primer, the hybrid primer of these embodiments of the invention enhance the adhesive strength between basecoat and waterborne primer.

Accordingly, in certain embodiments of the invention, the waterborne hybrid primer comprises a crosslinked network formed from an epoxy resin and one or more of a polysiloxane and/or a silicon based compound containing one or more amino or hydroxyl functional groups.

The epoxy resin includes, but is not limited to, epoxies formed from epichlorohydrin and one or more bisphenol compounds. The one or more bisphenol compounds can be any suitable bisphenol compound, and can be selected based on the end properties desired from the epoxy resin portion of the hybrid primer.

In certain embodiments, the bisphenol compound includes but is not limited to one or more compounds selected from the following:

| Structural formula | Name | CAS |
|---|---|---|
| 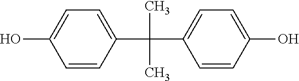 [SMILES: CC(C)(c1ccc(O)cc1)c1ccc(O)cc1] | Bisphenol A | 80-05-7 |
| 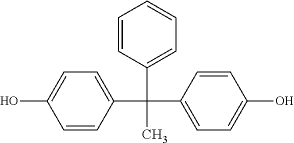 [SMILES: CC(c1ccccc1)(c1ccc(O)cc1)c1ccc(O)cc1] | Bisphenol AP | 1571-75-1 |
| 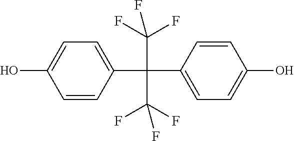 [SMILES: Oc1ccc(C(c2ccc(O)cc2)(C(F)(F)F)C(F)(F)F)cc1] | Bisphenol AF | 1478-61-1 |
| 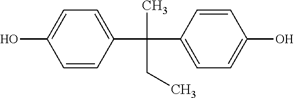 [SMILES: CCC(C)(c1ccc(O)cc1)c1ccc(O)cc1] | Bisphenol B | 77-40-7 |
| 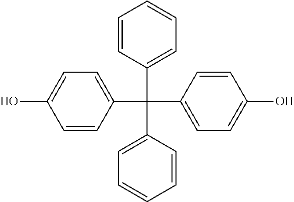 [SMILES: Oc1ccc(C(c2ccccc2)(c2ccccc2)c2ccc(O)cc2)cc1] | Bisphenol BP | 1844-01-5 |
| 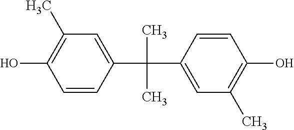 [SMILES: Cc1cc(C(C)(C)c2ccc(O)c(C)c2)ccc1O] | Bisphenol C | 79-97-0 |
| 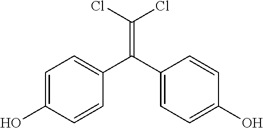 [SMILES: Oc1ccc(C(=C(Cl)Cl)c2ccc(O)cc2)cc1] | Bisphenol C 2 | 14868-03-2 |
| 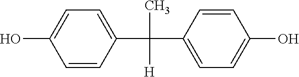 [SMILES: CC(c1ccc(O)cc1)c1ccc(O)cc1] | Bisphenol E | 2081-08-5 |
| 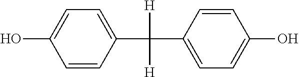 [SMILES: Oc1ccc(Cc2ccc(O)cc2)cc1] | Bisphenol F | 620-92-8 |
| 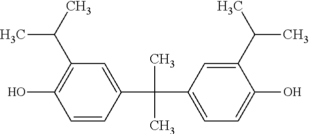 [SMILES: CC(C)c1cc(C(C)(C)c2ccc(O)c(C(C)C)c2)ccc1O] | Bisphenol G | 127-54-8 |
| 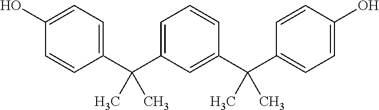 [SMILES: CC(C)(c1ccc(O)cc1)c1cccc(C(C)(C)c2ccc(O)cc2)c1] | Bisphenol M | 13595-25-0 |
| 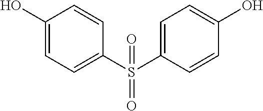 [SMILES: O=S(=O)(c1ccc(O)cc1)c1ccc(O)cc1] | Bisphenol S | 80-09-1 |
| 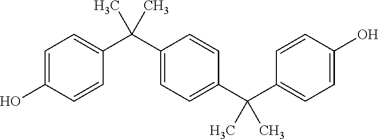 [SMILES: CC(C)(c1ccc(O)cc1)c1ccc(C(C)(C)c2ccc(O)cc2)cc1] | Bisphenol P | 2167-51-3 |
| 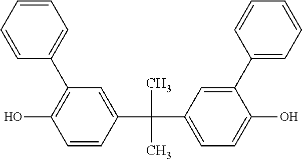 [SMILES: CC(C)(c1ccc(O)c(-c2ccccc2)c1)c1ccc(O)c(-c2ccccc2)c1] | Bisphenol PH | 24038-68-4 |
| 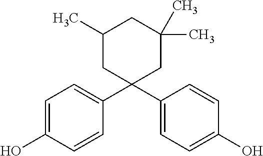 [SMILES: CC1CC(C)(C)CC(c2ccc(O)cc2)(c2ccc(O)cc2)C1] | Bisphenol TMC | 129188-99-4 |
| 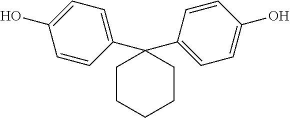 [SMILES: Oc1ccc(C2(c3ccc(O)cc3)CCCCC2)cc1] | Bisphenol Z | 843-55-0 |
| 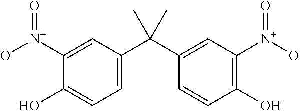 | Dinitrobisphenol A | 5329-21-5 |
| 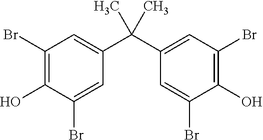 [SMILES: CC(C)(c1cc(Br)c(O)c(Br)c1)c1cc(Br)c(O)c(Br)c1] | Tetrabromobisphenol A | 79-94-7 |

Preferably, the one or more bisphenol compounds are selected from the group consisting of bisphenol A, bisphenol B, bisphenol E, bisphenol F, and bisphenol AF.

Curing (or crosslinking) of the epoxy resin may be achieved by reacting an epoxy with itself (homopolymerisation) or by forming a copolymer with polyfunctional curatives or hardeners. This curing is what produces the qualities of the substance such as resistance, durability, versatility, and adhesion. Any desired molecule containing a reactive hydrogen may be used to react with the epoxide groups of the epoxy resin. Common classes of hardeners for epoxy resins include amines, acids, acid anhydrides, phenols, alcohols and thiols. These have a relative reactivity (lowest first) approximately in the order: phenol<anhydride<aromatic amine<cycloaliphatic amine<aliphatic amine<thiol.

While some epoxy resin/hardener combinations will cure at ambient temperature, some may require heat. Temperature is sometimes increased in a step-wise fashion to control the rate of curing and prevent excessive heat build-up from the exothermic reaction.

Hardeners which show only low or limited reactivity at ambient temperature, but which react with epoxy resins at elevated temperature are referred to as latent hardeners. When using latent hardeners, the epoxy resin and hardener may be mixed and stored for some time prior to use, which is advantageous for many industrial processes.

The epoxy curing reaction may also be accelerated by addition of small quantities of accelerators. Tertiary amines, carboxylic acids and alcohols (especially phenols) are effective accelerators.

The epoxy resin can be prepared using conventional methods. For example, one method for preparing the epoxy resin used in the present invention is as follows: First, deionized water as solvent, a disperser, a defoamer, a water compatible co-solvent, and an anti-rust agent are combined in a first vessel. Then, pigments, fillers, and anti-corrosion agents are combined in a second vessel, into which the contents of the first vessel are then added and mixed at high speed to disperse the particles contained therein. After cooling to room temperature, the epoxy latex, a levelling agent, and additional defoamer are added and mixed at room temperature.

In some embodiments of the epoxy-polysiloxane waterborne hybrid primer, the silicon based compound containing one or more amino or hydroxyl functional groups is selected from the group consisting of polysiloxanes containing one or more amino or hydroxyl functional groups and organosilanes containing one or more amino or hydroxyl functional groups.

In some embodiments, the silicon based compound containing one or more amino or hydroxyl functional groups has a formula R¹O—[O—Si—(OH)(—R²—NH₂)]ₓ—OR³, where R¹ is independently H, an alkyl group, an aryl group, or a group of formula (R⁴O)2Si—, each R² is independently an alkylene or arylene group, R³ is independently H, an alkyl group, an aryl group, or a group of formula —Si(—OR⁴)₂(—R²—NH₂), each R⁴ is independently H, an alkyl group or an aryl group, and x is an integer from 1 to 5000; preferably R¹ is H and each R² is a C₁-C₆ alkylene group; more preferably each R² is a C₃ alkylene group.

The epoxy-polysiloxane waterborne hybrid primer of some embodiments of the invention can be prepared by any desired method by which the epoxy resin and organosilicon based compound containing one or more amino or hydroxyl functional groups react and become a crosslinked network, including, but not limited to: (a) reacting the epoxy resin and the polysiloxane and/or organosilicon based compound containing one or more amino or hydroxyl functional groups in an aqueous medium to form the crosslinked epoxy-polysiloxane hybrid primer, or (b) bonding the organosilicon based compound containing one or more amino or hydroxyl functional groups to hydroxyl or amino groups contained on a surface of a structure on which the hybrid primer will be placed, wherein, optionally prior to bonding of the organosilicon based compound containing one or more amino or hydroxyl functional groups, the surface of the structure is optionally modified with an etching primer in order to form the hydroxyl or amino groups on the surface of the structure, reacting the epoxy resin with the one or more amino functional groups of the thus bound organosilicon based compound containing one or more amino or hydroxyl functional groups, to form the crosslinked epoxy resin and polysiloxane hybrid primer.

In either of the above noted methods (a) and (b), an embodiment of the method of the invention includes, prior to reacting with the epoxy resin, hydrolyzing and condensing the organosilicon based compound containing one or more amino or hydroxyl functional groups to form a crosslinked polysiloxane network.

One embodiment of the present invention hybrid epoxy-polysiloxane waterborne primer can be formed by reacting an epoxy resin with a polysiloxane containing one or more amine and/or hydroxyl functional groups and an organosilane containing one or more amine and/or hydroxyl functional groups. In such a reaction, the equivalent weight ratio of epoxy to amine can be in a range of 1.1 to 2.5, preferably from about 1.4 to 1.9, more preferably about 1.7. An aliphatic amine curing agent (such as Anquamine 721) can be used, which reacts with epoxide rings on the epoxy resin to develop a crosslinked epoxy network. The polysiloxane network can be prepared by condensing a hydrolyzed polysiloxane and the organosilane to generate a crosslinked polysiloxane network. In addition, the amine group on the polysiloxane and organosilane also reacts with epoxide rings in the epoxy resin to crosslink the two networks with each other. The result is not a traditional interpenetrating polymer network (IPN). Rather, the crosslinking density in a film formed from the hybrid primer is dramatically increased by those reactions.

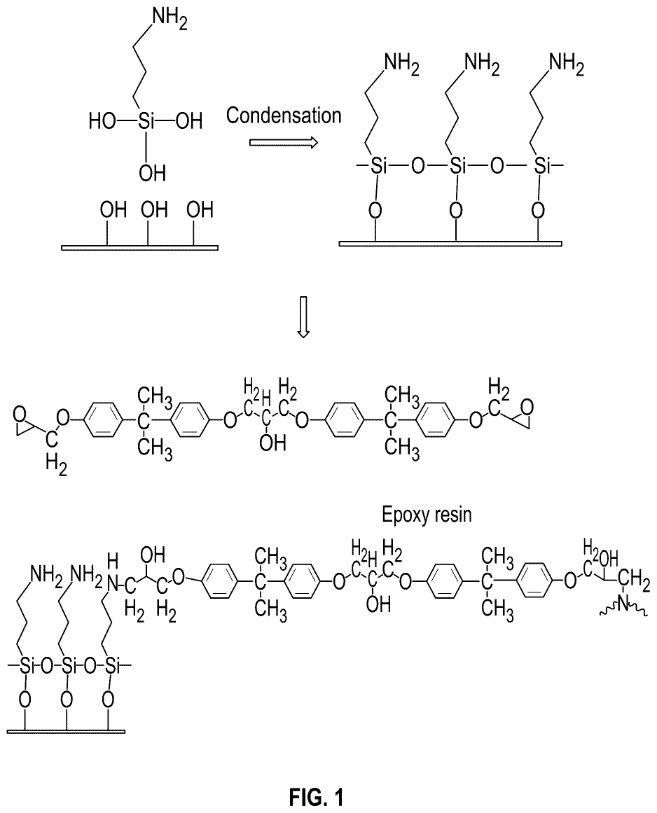

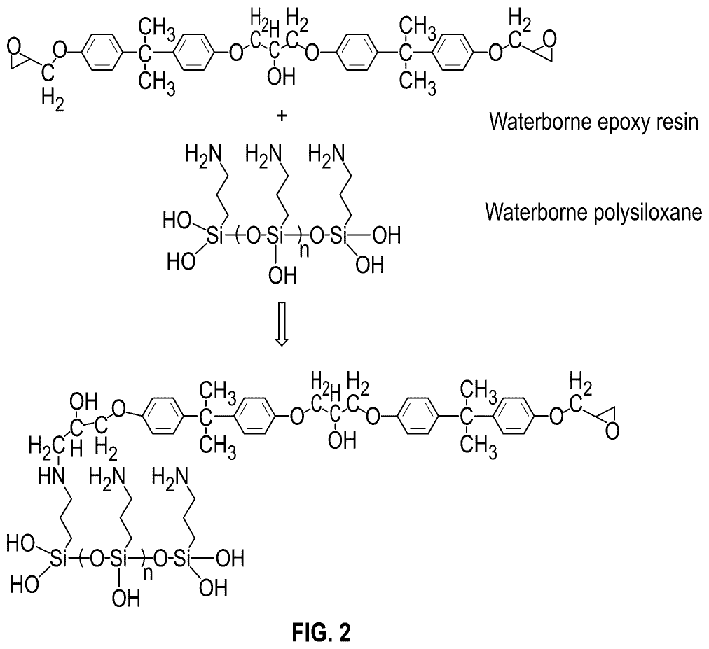

FIGS. 1 and 2 further help explain the reactions that can be used in preparing embodiments of the hybrid epoxy-polysiloxane waterborne primer of the present invention. A silicon based compound having one or more amino groups, for instance 3-aminopropyltriethoxysilane, can be hydrolyzed first, then condensed with hydroxyl groups on a cold rolled steel (CRS) substrate as shown in FIG. 1. Further, the silicon based compound having one or more amino groups will also react with the epoxy resin to bind with the crosslinked epoxy network, which improves the adhesive strength of the exemplified waterborne primer, particularly with a steel substrate. Further condensation of hydroxyl groups in the reacted silicon based compound can create a further crosslinked network. A hybrid epoxy-polysiloxane waterborne primer of the present invention can be obtained using a crosslinked epoxy resin (for example, obtained by reaction of an epoxy resin and an amine curing agent), and a polysiloxane having amine or hydroxyl functional groups, which can be connected by reaction of the polysiloxane with amine or hydroxyl groups and the epoxy resin as shown in FIG. 2 (exemplified for the polysiloxane with amine groups).

By including a polysiloxane with amine and/or hydroxyl groups, such as, for example, aminoethylaminopropyl-methylsilsesquioxane, two networks of epoxy and polysiloxane can be connected to each other by reaction of the amine or hydroxyl group with silane and the epoxide ring in the epoxy resin. In the resulting hybrid primer, the hydrophobic property of the polysiloxane portion provides excellent anti-degradation performance of the coating produced by the waterborne hybrid primer, which prevents the penetration of water moisture. Combined with the excellent chemical and thermal stability and mechanical strength of the epoxy resin, the thus resulting hybrid waterborne epoxy-polysiloxane primer of these embodiments exhibit much better performance compared with conventional solvent borne primers.

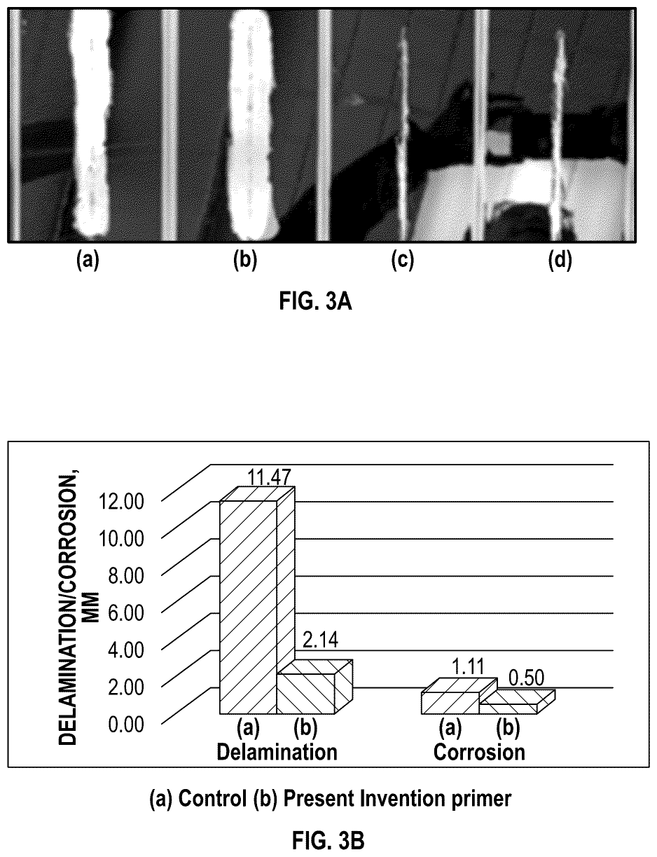

The anticorrosion performance of these hybrid epoxy-polysiloxane waterborne primers of embodiments of the present invention is dramatically improved when compared with a 2K polyurethane solvent borne control primer. FIGS. 3A and 3B provide a detailed comparison, which shows a much smaller area of delamination on metal substrates coated with embodiments of the present invention hybrid epoxy-polysiloxane waterborne primer (samples (c) and (d)), which showed (in FIG. 3B) a calculated delamination number of 2.14 mm compared with a calculated delamination number of 11.47 mm for panels coated with the 2K polyurethane solvent borne control primer (samples (a) and (b)). Further, the area of corrosion on the metal substrate coated with the embodiments of the present invention hybrid epoxy-polysiloxane waterborne primers was almost 50% lower compared with the 2K polyurethane solvent borne control primer (0.50 vs. 1.11).

In using the hybrid epoxy-polysiloxane waterborne primers of embodiments of the present invention, it is not necessary to apply an etch primer or any other surface treatment process. Such etch primer or surface treatment is typically required when using a conventional 2K polyurethane solvent borne control primer in order to enhance the adhesive strength between the conventional primer and the cold rolled steel substrate. However, when using the hybrid epoxy-polysiloxane waterborne primers of embodiments of the present invention, no such etch primer or surface treatment is required, although it can be used if desired in order to further enhance adhesion strength of the present invention hybrid primer to the substrate. In a comparison of the performance of embodiments of the present invention hybrid epoxy-polysiloxane waterborne primers applied to a cold rolled steel substrate without the use of an etch primer against a conventional 2K polyurethane solvent borne control primer applied with use of an initial etch primer on a cold rolled steel substrate, the chemical resistance, flexibility, adhesive strength, and optical appearance of the present invention embodiments were surprisingly nearly the same compared to the control, but without the need to use an etch primer for the hybrid epoxy-polysiloxane waterborne primers of embodiments of the present invention.

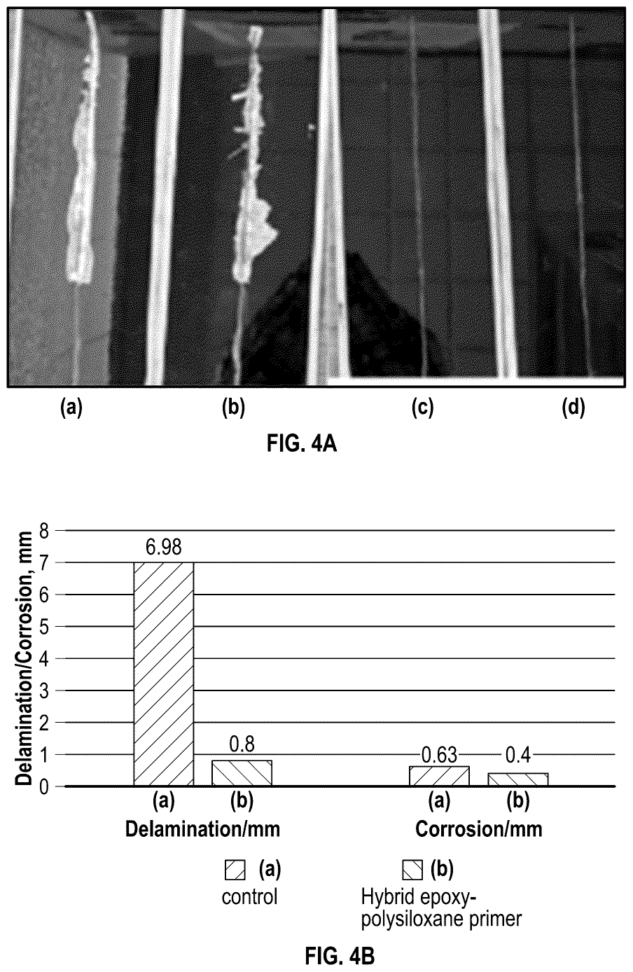

The excellent anticorrosion performance of embodiments of the hybrid epoxy-polysiloxane waterborne primers of the present invention have also been found. FIGS. 4A and 4B show the results of a salt spray chamber test for cold rolled steel substrates coated with embodiments of the present invention hybrid epoxy-polysiloxane waterborne primers prepared using a combination of polydimethylsiloxane (PDMS) and organosilane, each having amino or hydroxyl functional groups (samples (c) and (d)) compared to such substrates coated with the conventional 2K polyurethane solvent borne control primer (samples (a) and (b)). As shown in the figure, much better anticorrosion is achieved with the embodiments of the present invention hybrid epoxy-polysiloxane waterborne primer as compared to the conventional 2K polyurethane solvent borne control primer. These results are graphically shown in FIG. 4B, with the darker boxes (a) being the control and the lighter boxes (b) being the embodiments of the hybrid epoxy-polysiloxane waterborne primers of the present invention.

Excellent anti-degradation performance has also been shown with embodiments of the present invention hybrid epoxy-polysiloxane waterborne primers prepared using a combination of polydimethylsiloxane (PDMS) and organosilane, each having amino or hydroxyl functional groups, when compared with the conventional 2K polyurethane solvent borne control primer. After six days of testing in a humidity chamber, the surface of the control coated substrate became rough and exhibited many blisters, making measurement of DOI (distinctness-of-image) by instrument impossible. However, on substrates coated with embodiments of the present invention hybrid epoxy-polysiloxane waterborne primers, a smooth surface still existed and the coated substrates showed only slightly decreased DOI between day one (90.5) and day six (86). The adhesive strength of coatings on the substrates coated with the conventional 2K polyurethane solvent borne control primer was totally degraded, resulting in 100% of adhesive failure between the conventional control primer and a polyurethane basecoat after panels were removed from the chamber and exposed at room temperature for one hour. Even though there is some recovery of adhesive strength after the substrates are exposed at room temperature for 24 hours, poor adhesive strength of control coating with 42% of adhesive failure between the polyurethane basecoat and the control primer was observed. The embodiments of the present invention hybrid epoxy-polysiloxane waterborne primers, on the other hand, retained greater than 90% of adhesion (less than 10% adhesive failure) through the humidity chamber testing.

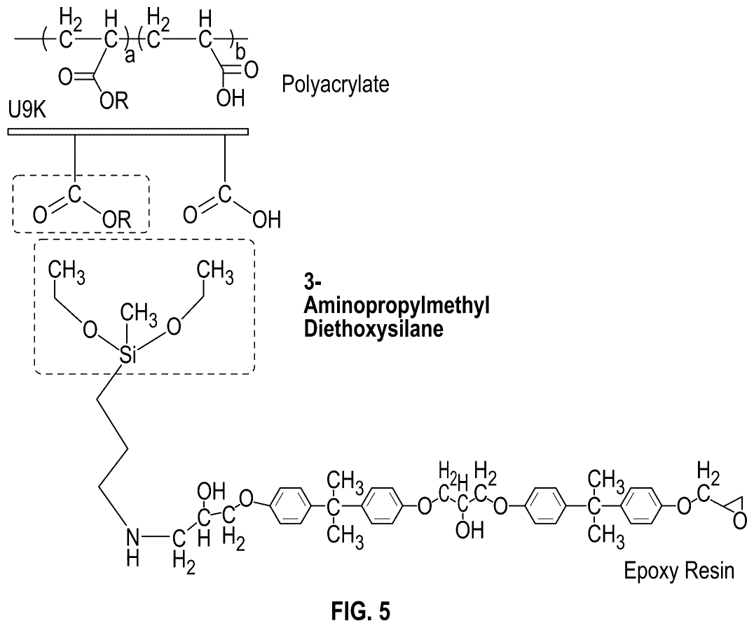

While not wanting to be bound to any particular mechanism of action, it is believed that the strong adhesive strength between basecoat and hybrid epoxy-polysiloxane waterborne primers of the present invention can be attributed to improved contacting or physical interlocking between the present invention hybrid epoxy-polysiloxane waterborne primers and the basecoat. A strong interlock will significantly improve adhesive strength between basecoat and hybrid waterborne primer. Polydimethylsiloxane (PDMS) is an elastomer with excellent optical, electrical and mechanical properties, which makes it well-suited for several engineering applications. PDMS also demonstrates other advantages such as non-toxicity and environmental friendliness, weatherability, water repellency, abrasion resistance and physiological inertia, which have been widely used in coating technology. In particular, the hydrophobic property of PDMS can provide excellent anti-corrosion performance for a coating layer since this hydrophobicity can repel water strongly. In certain embodiments of the present invention, the hybrid epoxy-polysiloxane primer can include PDMS as part of the polysiloxane portion of the hybrid. In such embodiments, the PDMS is added into the coating solution, along with an organosilane containing one or more amine or hydroxy functional groups. A suitable such organosilane would include, but is not limited to, 3-aminopropylmethyldiethoxysilane. FIG. 5 shows a schematic illustration of such interlocking between a 3-aminopropylmethyldiethoxysilane group (as found in certain embodiments of the present invention) and the polyacrylate of a typical basecoat layer.

By way of example, a coating solution with a hybrid epoxy-polysiloxane waterborne primer of the present invention is sprayed on a cold rolled steel substrate by spray gun without applying etch primer. After drying overnight at room temperature (23° C.) and normal humidity (~50%), the coatings are sanded using 320 # and 600 # sandpaper, separately. Finally, a polyacrylate basecoat and clearcoat are sprayed on the coating separately and dried. Panels coated with the hybrid epoxy-polysiloxane waterborne primer of embodiments of the present invention and with the polyurethane control are cured at room temperature for seven days prior to analysis/testing.

Table 1 shows the performance of an exemplary hybrid epoxy-polysiloxane waterborne primer of the invention and a conventional 2K solvent borne polyurethane as control. As shown in the table, the hybrid epoxy-polysiloxane waterborne primer of the present invention provides similar performance in the areas of chemical resistance, flexibility, adhesive strength, and optical appearance, without the need for an etch primer.

TABLE 1

| | | |
|---|---|---|
| | | Present invention |
| | | hybrid epoxy- |
| | 2K solvent borne | polysiloxane |
| Primer | PU control | waterborne primer |

Primer on Substrate of Cold-Rolled Steel

| | | |
|---|---|---|
| Cross-hatch (dry) | 5B | 5B |
| MEK rub (cycle) | >300 | >300 |

Full Set Panel

| Coating layer | Etch primer/primer/basecoat/clearcoat | |
|---|---|---|
| Thickness, mil | 0.24/6.36/0.4/3.52 | 0/3.96/0.4/3.52 |
| Impact (direct/indirect), psi | 150/160 | 140/160 |
| Conical mandrel bend | Pass | Pass |
| Gloss (20 degree) | 89.3 | 88.7 |
| DOI | 96.5 | 94.9 |

| | |
|---|---|
| Dry time (tack-free), min | Longer than 45 min at r.t., shorter with |
| | forced dry |
| Pot life, min | >60 |

The following tests are used in characterization of various embodiments of the present invention hybrid epoxy-polysiloxane primer:

Chemical resistance of primer—To check chemical resistance of primer, panels coated with etch primer and primer are rubbed by a hammer covered with three layers of fiber paper soaked with MEK solvent. The specification of chemical resistance with MEK testing is more than 300 cycles without surface being dissolved and steel surface being exposed (ASTM D5402-19).

Sanding capability-Sanding capability of films formed from the control and from the hybrid epoxy-polysiloxane waterborne primer of the present invention are evaluated by blowing primer coated on panels with a venturi blower for one hour at room temperature, then the surface of the primer is sanded with 320 # and 600 # sandpaper, respectively. Basecoat and clearcoat are sprayed on the surface of the sanded primer and optical appearance is evaluated subsequently. Using this method, there is no fundamental difference in optical appearance for samples sanded after one airflow drying and those dried at room temperature overnight.

Adhesive strength—The adhesive strength of film is evaluated by crosshatch testing in accordance with ASTM D3359. The failure mode of film is also assessed based on the observation of peeled film on tape and substrate. This test rates the adhesion strength of film on each layer by removing pressure-sensitive tape sticked on the film cut by crosshatch. Films made of embodiments of the present invention provide much stronger adhesive strength, with no adhesive loss is seen when the sample is exposed at room temperature for 1 h after a humidity test. On the contrary, films made of the control show 100% of adhesive loss after exposure at room temperature for 1 h after the humidity test.

Impact resistance—Impact resistance of film coated on panels are assessed in accordance with ASTM D5420. The data will be repeated twice, and both coated and non-coated sides will be tested and recorded as direct and non-direct impact strength.

Conical Mandrel Bend—Flexible capability of film is evaluated by Conical Mandrel Bend in accordance with ASTM D522.

Stone chip testing—Durability of film is measured in accordance with GM 14729.

Optical appearance—Optical appearance of film is evaluated by Gloss Retention (20 Deg Gloss) and DOI Retention (Wavescan). Embodiments of the present invention and control show almost no difference in the gloss 20 and DOI measurements between the two samples, before and after a humidity chamber test.

Humidity Chamber—Panels with edges painted are put into a humidity chamber at a temperature of about 30° C. for 4 days in accordance with GM 14729. The panels are dried with fiber paper after removal from the chamber and exposed at room temperature for 1 and 24 hours, then Gloss (20 degree), DOI and cross-hatch are measured for each sample.

Salt fog chamber—Panels with edges painted and having one line scratched in the middle are put in the salt fog chamber at a temperature of about 30° C. for 20 days in accordance with ASTM B117. The panels are washed with hot water and any loose film removed with a metal specula after removal from the chamber. The size of delamination and corrosion area are measured, and values are determined by an average of ten measured data points. Using a statistical t-Test analysis, the testing shows no significant difference (P=0.00) in corrosion between control and embodiments of the present invention, but does show a significant difference (P=0.22) in delamination results between control and embodiments of the present invention, with the panels coated with embodiments of the present invention demonstrating better performance on anti-delamination than that of the control.

Stability test—Viscosity and pH of the hybrid epoxy-polysiloxane primers (and solutions thereof) are measured prior to placement in an oven at 40° C. The viscosity and pH of the samples are then checked after 10, 20 and 30 days to confirm stability. Using this method, a Stable solution is achieved with the hybrid epoxy-polysiloxane waterborne primers of the present invention, which show almost no change in viscosity of solution after 24 days in an oven at 40° C.

In preparing the hybrid primers of the present invention, an epoxy waterborne primer, optionally including one or more solvents, additives, pigments, or corrosion inhibitors, is prepared by combining the optional components and mixing to fully disperse, such as, for example, by stirring with a dispersing disc for one hour, then the epoxy latex is added to the mixture, followed by cooling the resulting composition to room temperature. The resulting epoxy waterborne primer is combined with the silicon based compound having one or more amine or hydroxyl groups and optionally an amine curing agent, and the mixture stirred prior to coating onto the substrate.

While the embodiments discussed herein have been related to the hybrid waterborne primers and methods discussed above, these embodiments are intended to be examples only and are not intended to limit the applicability of these embodiments to only those discussions set forth herein.

The above description is merely illustrative of several possible embodiments of various aspects of the present invention, wherein equivalent alterations and/or modifications will occur to others skilled in the art upon reading and understanding this specification and the annexed drawings. In addition, although a particular feature of the invention may have been disclosed with respect to only one of several implementations, such feature may be combined with one or more other features of the other implementations as may be desired and advantageous for any given or particular application.

The following are non-limiting examples of some embodiments of the present invention:

Embodiment 1. A hybrid primer comprising a crosslinked network formed from an epoxy resin and a silicon based compound containing one or more amino or hydroxyl functional groups.

Embodiment 2. The hybrid primer of Embodiment 1, wherein the silicon based compound containing one or more amino or hydroxyl functional groups is one or more members selected from the group consisting of polysiloxanes containing one or more amino or hydroxyl functional groups and organosilanes containing one or more amino or hydroxyl functional groups.

Embodiment 3. The hybrid primer one of Embodiments 1 or 2, wherein the epoxy resin is formed of units from epichlorohydrin and one or more bisphenol compounds.

Embodiment 4. The hybrid primer of any one of Embodiments 1 to 3, wherein the one or more bisphenol compounds are selected from the group consisting of bisphenol A, bisphenol B, bisphenol E, bisphenol F, and bisphenol AF.

Embodiment 5. The hybrid primer of any one of Embodiments 1 to 4, wherein the silicon based compound containing one or more amino or hydroxyl functional groups has a formula R¹O—[O—Si—(OH)(—R²—NH₂)]ₓ—OR³, where R¹ is independently H, an alkyl group, an aryl group, or a group of formula (R⁴O) 2Si—, each R² is independently an alkylene or arylene group, R³ is independently H, an alkyl group, an aryl group, or a group of formula Si(—OR⁴)₂(—R²—NH₂), each R⁴ is independently H, an alkyl group or an aryl group, and x is an integer from 1 to 5000.

Embodiment 6. The hybrid primer of Embodiment 5, wherein R¹ is H and each R² is a C₁-C₆ alkylene group.

Embodiment 7. The hybrid primer of one of Embodiments 5 or 6, wherein each R² is a C₃ alkylene group.

Embodiment 8. The hybrid primer of any one of Embodiments 1 to 7, wherein the crosslinked polymer network is a semi-interpenetrating crosslinked network.

Embodiment 9. A waterborne hybrid primer composition comprising the hybrid primer of any one of Embodiments 1 to 8 in an aqueous medium.

Embodiment 10. A method of preparing the hybrid primer of any one of Embodiments 1 to 8, comprising:
reacting the epoxy resin and the organosilicon based compound containing one or more amino or hydroxyl functional groups in an aqueous medium to form epoxy-polysiloxane hybrid primer.

Embodiment 11. The method of Embodiment 10, wherein the organosilicon based compound containing one or more amino or hydroxyl functional groups is one or more members selected from the group consisting of polysiloxanes containing one or more amino or hydroxyl functional groups and organosilanes containing one or more amino or hydroxyl functional groups.

Embodiment 12. The method of one of Embodiment 10 or Embodiment 11, wherein prior to reacting with the epoxy resin, the organosilicon based compound containing one or more amino or hydroxyl functional groups is hydrolyzed and condensed to form a crosslinked polysiloxane network.

Embodiment 13. A method of preparing the hybrid primer of any one of Embodiments 1 to 8, comprising:
bonding the organosilicon based compound containing one or more amino or hydroxyl functional groups to hydroxyl or amino groups contained on a surface of a structure on which the hybrid primer will be placed, wherein, optionally prior to bonding of the organosilicon based compound containing one or more amino or hydroxyl functional groups, the surface of the structure is optionally modified with an etching primer in order to form the hydroxyl or amino groups on the surface of the structure,
reacting the epoxy resin with the one or more amino functional groups of the thus bound organosilicon based compound containing one or more amino or hydroxyl functional groups, to form the crosslinked epoxy resin and polysiloxane hybrid primer.

Embodiment 13. The method of Embodiment 13, wherein the silicon based compound containing one or more amino or hydroxyl functional groups is one or more members selected from the group consisting of polysiloxanes containing one or more amino or hydroxyl functional groups and organosilanes containing one or more amino or hydroxyl functional groups.

Embodiment 14. The method of one of Embodiment 12 or Embodiment 13, wherein prior to reacting with the epoxy resin, the organosilicon based compound containing one or more amino or hydroxyl functional groups is hydrolyzed and condensed to form a crosslinked polysiloxane network.

Additional modifications and variations of the present invention are possible in light of the above teachings. It is therefore to be understood that within the scope of the appended claims, the invention may be practiced otherwise than as specifically described herein.

1. A hybrid primer comprising a crosslinked network formed from aqueous medium containing an epoxy resin and a silicon based compound containing one or more amino or hydroxyl functional groups.

2. The hybrid primer of claim 1, wherein the silicon based compound containing one or more amino or hydroxyl functional groups is one or more members selected from the group consisting of polysiloxanes containing one or more amino or hydroxyl functional groups and organosilanes containing one or more amino or hydroxyl functional groups.

3. The hybrid primer of claim 1, wherein the epoxy resin is formed of units from epichlorohydrin and one or more bisphenol compounds.

4. The hybrid primer of claim 3, wherein the one or more bisphenol compounds are selected from the group consisting of bisphenol A, bisphenol B, bisphenol E, bisphenol F, and bisphenol AF.

5. The hybrid primer of claim 1, wherein the silicon based compound containing one or more amino or hydroxyl functional groups has a formula R¹O—[O—Si—(OH)(—R²—NH₂)]ₓ—OR³, where R¹ is independently H, an alkyl group, an aryl group, or a group of formula (R⁴O)2Si—, each R² is independently an alkylene or arylene group, R³ is independently H, an alkyl group, an aryl group, or a group of formula —Si(—OR⁴)₂(—R²—NH₂), each R⁴ is independently H, an alkyl group or an aryl group, and x is an integer from 1 to 5000.

6. The hybrid primer of claim 5, wherein R¹ is H and each R² is a C₁-C₆ alkylene group.

7. The hybrid primer of claim 5, wherein each R² is a C₃ alkylene group.

8. The hybrid primer of claim 1, wherein the crosslinked polymer network is a semi-interpenetrating crosslinked network.

9. A waterborne hybrid primer composition comprising the hybrid primer of claim 1 in the aqueous medium.

10. A method of preparing the hybrid primer of claim 1, comprising:
reacting the epoxy resin and the organosilicon based compound containing one or more amino or hydroxyl functional groups in the aqueous medium to form epoxy-polysiloxane hybrid primer.

11. The method of claim 10, wherein the organosilicon based compound containing one or more amino or hydroxyl functional groups is one or more members selected from the group consisting of polysiloxanes containing one or more amino or hydroxyl functional groups and organosilanes containing one or more amino or hydroxyl functional groups.

12. The method of claim 10, wherein prior to reacting with the epoxy resin, the organosilicon based compound containing one or more amino or hydroxyl functional groups is hydrolyzed and condensed to form a crosslinked polysiloxane network.

13. A method of preparing the hybrid primer of claim 1, comprising:
bonding the organosilicon based compound containing one or more amino or hydroxyl functional groups to hydroxyl or amino groups contained on a surface of a structure on which the hybrid primer will be placed, wherein, optionally prior to bonding of the organosilicon based compound containing one or more amino or hydroxyl functional groups, the surface of the structure is optionally modified with an etching primer in order to form the hydroxyl or amino groups on the surface of the structure,
reacting the epoxy resin with the one or more amino functional groups of the thus bound organosilicon based compound containing one or more amino or hydroxyl functional groups, and
interpenetrating the resulting composition to form the crosslinked, interpenetrating epoxy resin and polysiloxane hybrid primer.

14. The method of claim 13, wherein the silicon based compound containing one or more amino or hydroxyl functional groups is one or more members selected from the group consisting of polysiloxanes containing one or more amino or hydroxyl functional groups and organosilanes containing one or more amino or hydroxyl functional groups.

15. The method of claim 13, wherein prior to reacting with the epoxy resin, the organosilicon based compound containing one or more amino or hydroxyl functional groups is hydrolyzed and condensed to form a crosslinked polysiloxane network.

16. The hybrid primer of claim 1, wherein the aqueous medium has a continuous phase of water that makes up at least 50 weight percent of the aqueous medium.
